(19) United States
(12) Patent Application Publication
(10) Pub. No.: US 2005/0276008 A1
(43) Pub. Date: Dec. 15, 2005

(54) Computer enclosure

(75) Inventors: Yun-Lung Chen, Tu-Cheng (TW); Quan-Guang Du, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/018,285

(22) Filed: Dec. 20, 2004

(30) Foreign Application Priority Data
Jun. 14, 2004 (CN) 200420047361.3

(51) Int. Cl. G06F 1/16

(52) U.S. Cl. 361/683

(57) ABSTRACT

A computer enclosure includes a base (20) having a pair of opposite side panels (21), a rear panel (23) and a bottom panel (25), and a cover (10). A pair of horizontal slideways (2111) is defined in the side panels respectively. A pair of pivots (121) is formed on the cover, the pivots slidably and pivotally received in corresponding slideways of the base. In use, the cover is rotated to cover or uncover a front surface and a top surface of the base.

### BACKGROUND OF THE INVENTION

1. Field of the Invention

The present invention relates to a computer enclosure, and more particularly to a computer enclosure which facilitates maintenance of components accommodated therein.

2. Description of the Related Art

Typically, a plurality of panels is assembled via screws to form a computer enclosure. A plurality of necessary electronic components such as hard disc drive, central processing unit, motherboard, etc., is accommodated in the computer enclosure. However, it is boring and time-consuming to manipulate screws to open the computer enclosure in need of servicing the electronic components.

### SUMMARY OF THE INVENTION

Accordingly, an object of the present invention is to provide a computer enclosure which facilitates maintenance of components accommodated therein.

To achieve the above object, a computer enclosure in accordance with the present invention comprises a base comprising a pair of opposite side panels, a rear panel and a bottom panel, and a cover. A pair of horizontal slideways is defined in the side panels respectively. A pair of pivots is formed on the cover, the pivots slidably and pivotally received in corresponding slideways of the base. The cover is rotated to cover or uncover a front surface and a top surface of the base.

Other objects, advantages and novel features of the present invention will be drawn from the following detailed description of a preferred embodiment of the present invention with the attached drawings, in which:

### BRIEF DESCRIPTION OF THE DRAWINGS

FIG. 1 is an exploded, isometric view of a computer enclosure in accordance with a preferred embodiment of the present invention, the computer enclosure comprising a base and a cover;

FIG. 2 is an isometric view of the cover of FIG. 1, but viewed from anther aspect; and

FIGS. 3-5 shows the process of opening an assembled computer enclosure.

### DETAILED DESCRIPTION OF THE PRESENT INVENTION

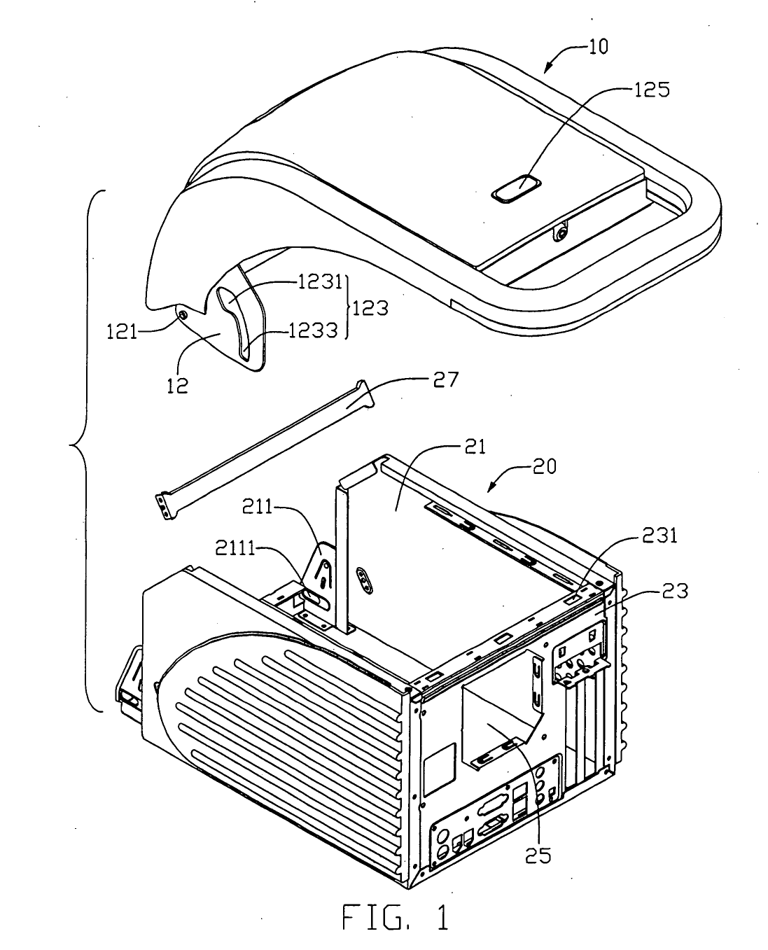

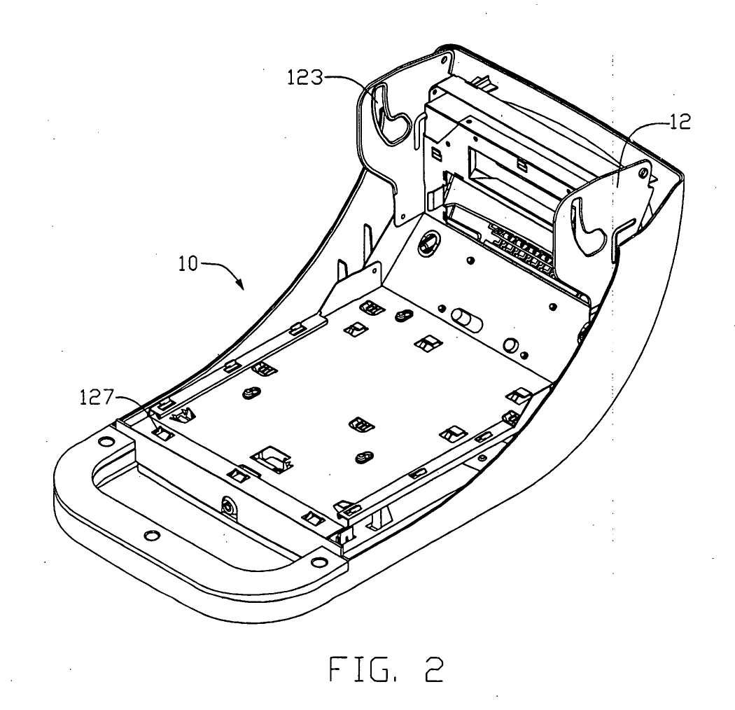

Referring to FIGS. 1 and 2, an enclosure of an electronic device in accordance with a preferred embodiment of the present invention comprises a cover 10, and a base 20.

The cover 10 comprises an arcuate plate, and a pair of opposite sidewalls 12 depends from a front portion of the plate adjacent opposite side edges respectively. A pivot 121 is formed perpendicularly outwardly from a front portion of each sidewall 12. An arcuate guideway 123 is defined in each sidewall 12 at rear of the pivot 121. The guideway 123 comprises a relatively wide portion 1231 and a relatively narrow portion 1233 in communication with the wide portion 1231. A push button 125 is disposed on a rear portion of the cover 10, for controlling catches 127 formed on a rear edge of the cover 10.

The base 20 comprises a pair of side panels 21, a rear panel 23, and a bottom panel 25. A pair of supporting plates 211 is attached to the side panels 21 respectively. A pair of horizontal slideways 2111 is defined in bottom portions of the supporting plates 211 respectively, for receiving pivots 121 of the cover 10 respectively. A plurality of catch holes 231 is defined in an upper edge of the rear panel 23, corresponding to the catches 127 of the cover 10. A stopper piece 27 is for extension through the guideways 123 of the cover 10.

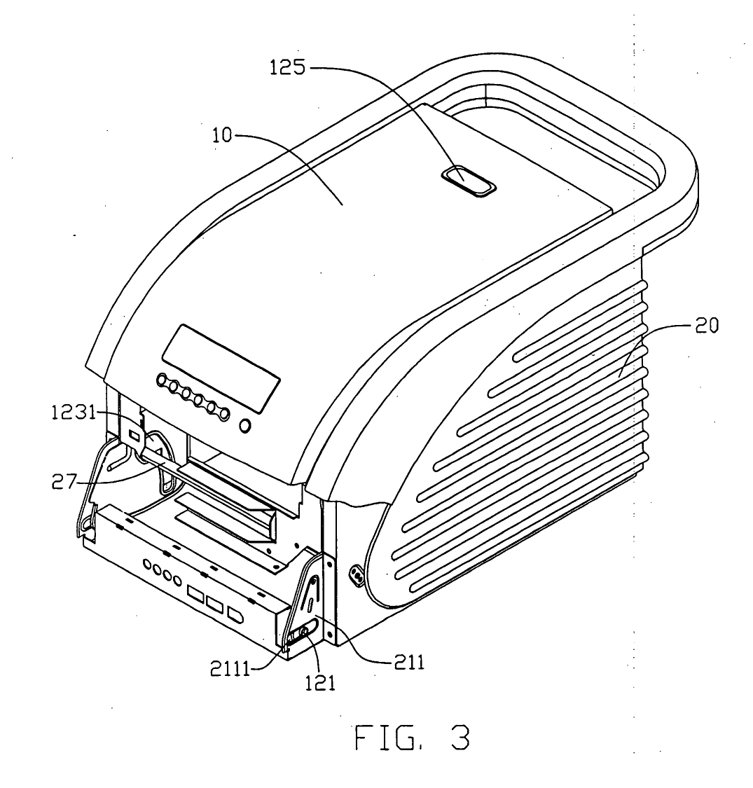

Referring to FIG. 3, the cover 10 is attached to the base 20. The pivots 121 of the cover 10 are positioned at rear ends of the slideways 2111 of the supporting plates 211 of the base 20 respectively. The stopper piece 27 is extended through the guideways 123 of the cover 10 and fixedly attached to the side panels 21 of the base 20. The catches 127 of the cover 10 are engaged in corresponding catch holes 231 of the rear panel 23 of the base 20. The cover 10 is designated at a closed position as shown in FIG. 3.

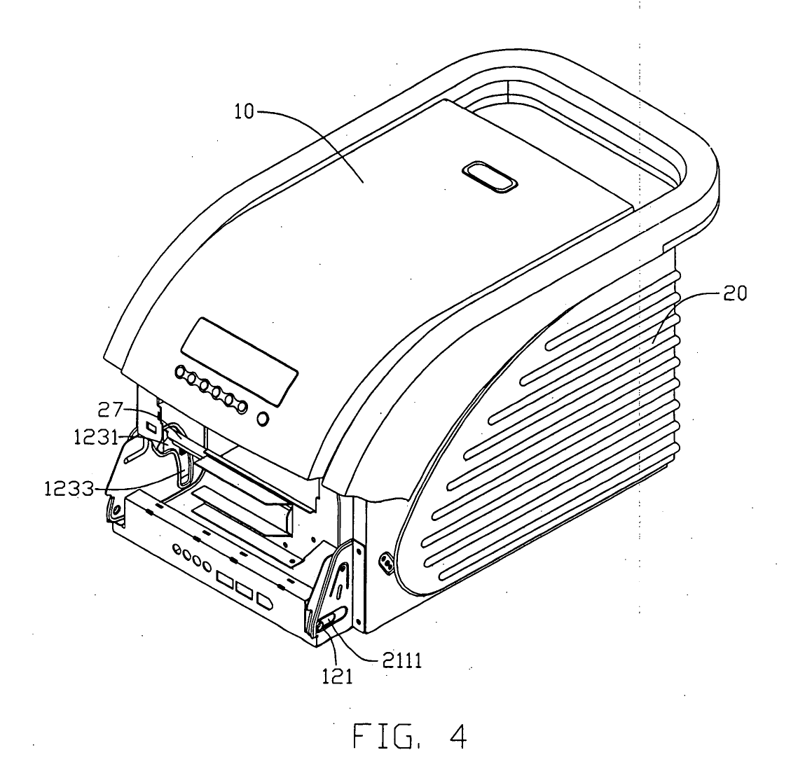

Referring to FIG. 4, to open the computer enclosure, the push button 125 is pushed to disengage the catches 127 of the cover 10 from the catch holes 231 of the base 20. The cover 10 is pushed forward with respect to the base 20, until the pivots 121 of the cover 10 contact front ends of the slideways 2111 of the supporting plates 211 respectively. The stopper piece 27 is relatively moved rearward in the wide portions 1231 of the guideways 123 of the cover 10.

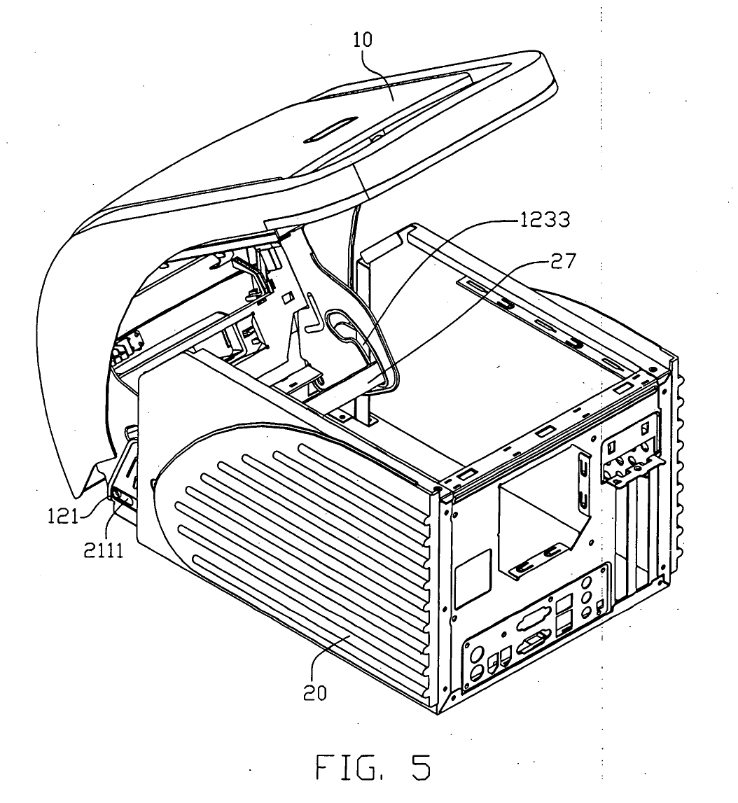

Referring to FIG. 5, the cover 10 is then rotated forward, the stopper piece 27 is relatively moved from the wide portions 1231 into the narrow portions 1233 of the guideways 123 of the cover 10, until the stopper piece 27 contacts distal ends of the guideways 123. The cover 10 is prevented from further movement by the stopper piece 27. The cover 10 is thus opened.

It is understood that the invention may be embodied in other forms, without departing from the spirit thereof. Thus, the present example and embodiment are to be considered in all respects as illustrative and not restrictive, and the invention is not to be limited to the details given herein.

1. A computer enclosure comprising:
a base comprising a pair of opposite side panels, a rear panel and a bottom panel, a pair of horizontal slideways defined in the side panels respectively; and
a cover covering a front surface and a top surface of the base, a pair of pivots formed on the cover, the pivots slidably and pivotally received in corresponding slideways of the base.

2. The computer enclosure as claimed in claim 1, wherein at least one guideway is defined in the cover, and a stopper piece is extended through said guideway and fixed to the side panels of the base.

3. The computer enclosure as claimed in claim 2, wherein said guideway is arcuate, and comprises a relatively wide portion and a relatively narrow portion in communication with the wide portion.

4. The computer enclosure as claimed in claim 1, wherein a plurality of catches is formed on the cover, and a plurality of catch holes is defined in a top edge of the rear panel of the base to receive corresponding catches of the cover.

5. The computer enclosure as claimed in claim 4, wherein a push button is provided on the cover to disengage the catches from the corresponding catch holes of the base.

6. The computer enclosure as claimed in claim 1, wherein each of the side panels comprises a supporting plate, and the slideways are defined in the support plates respectively.

7. A computer enclosure comprising:
a base; and
an arcuate cover slidably attached to the base;
wherein the cover is rotated with respect to the base in a limited range to uncover or cover the base.

8. The computer enclosure as claimed in claim 7, wherein a pair of guideways is defined in the cover, and a stopper piece is extended through the guideways and fixed to the base to limit rotation range of the cover.

9. The computer enclosure as claimed in claim 7, wherein a pair of supporting plates is formed on the base, a pair of slideways is defined in the supporting plates respectively, and a pair of pivots is formed at a front portion of the cover to engage in the slideways of the supporting plates respectively.

10. The computer enclosure as claimed in claim 9, wherein at least one catch is formed at a rear portion of the cover, and at least one catch hole is defined in the base to receive said catch of the cover.

11. An enclosure of an electronic device, comprising:
a base comprising a plurality of panels to surroundingly define a space of said electronic device between said plurality of panels, said space in communication with outside of said electronic device along at least one side thereof; and
a cover extending beside said base to fully cover said at least one side of said space in order to enclose said space incorporating with said base, said cover pivotably attached to said base and linearly movable along a direction perpendicular to said at least one side of said space during rotation of said cover for exposing said space from said at least one side.

12. The enclosure as claimed in claim 11, wherein said cover fully covers two neighboring sides of said space and linear movement of said cover is along said direction perpendicular to selective one of said two neighboring sides.

13. The enclosure as claimed in claim 11, wherein said cover has a pair of pivots to be received in a pair of slideways of said base respectively so as to be linearly slidable and pivotable therein in order to perform linear movement and said rotation of said cover.

14. The enclosure as claimed in claim 11, wherein said cover has a pair of guideways to receive commonly a stopper piece fixed to said base therein in order to perform linear movement and said rotation of said cover.
